(19) United States
(12) Patent Application Publication
(10) Pub. No.: US 2026/0004542 A1
(43) Pub. Date: Jan. 1, 2026

(54) CENTERING CONTENT LAYERS

(71) Applicant: QUALCOMM Incorporated, San Diego, CA (US)

(72) Inventors: Yellamraju TARUN, San Diego, CA (US); Mahdi SHAGHAGHI, San Diego, CA (US); Cullum James BALDWIN, San Diego, CA (US)

(21) Appl. No.: 18/755,568

(22) Filed: Jun. 26, 2024

(51) Int. Cl. G06V 10/25; G06T 1/20; G06T 5/50; G06T 7/70

(52) U.S. Cl. CPC G06V 10/25; G06T 1/20; G06T 5/50; G06T 7/70; G06T 2207/20221

(57) ABSTRACT

This disclosure provides systems, devices, apparatus, and methods, including computer programs encoded on storage media, for centering content layers. A graphics processor may obtain a first indication of a composition frame. The graphics processor may configure a render-frustum of a layer of the composition frame based on a head pose of a user and a region of interest (ROI) corresponding with the layer in response to the obtainment of the first indication. The graphics processor may render the layer based on the configured render-frustum. The graphics processor may output a second indication of the rendered layer.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques may not adequately address edge artifacts and errors when rendering content layers. There is a need for improved content rendering techniques.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a memory; and at least one processor coupled to the memory and, based at least in part on information stored in the memory, the at least one processor may be configured to obtain a first indication of a composition frame. The at least one processor may be configured to configure a render-frustum of a layer of the composition frame based on a head pose of a user and a region of interest (ROI) corresponding with the layer in response to the obtainment of the first indication. The at least one processor may be configured to render the layer based on the configured render-frustum. The at least one processor may be configured to output a second indication of the rendered layer.

In some aspects, the techniques described herein relate to a method of graphics processing, including: obtaining a first indication of a composition frame; configuring a render-frustum of a layer of the composition frame based on a head pose of a user and a region of interest (ROI) corresponding with the layer in response to the obtainment of the first indication; rendering the layer based on the configured render-frustum; and outputting a second indication of the rendered layer.

In some aspects, the techniques described herein relate to a method, where the first indication indicates a plurality of layers, where the composition frame includes the plurality of layers, where the plurality of layers includes the layer.

In some aspects, the techniques described herein relate to a method, further including: composing the composition frame based on the plurality of layers after the render of the layer based on the configured render-frustum.

In some aspects, the techniques described herein relate to a method, where configuring the render-frustum of the layer of the composition frame includes: identifying a content of interest (COI) of the layer; determining a set of limit boundaries for the ROI based on the identification of the COI; and configuring a field of view (FoV) of the render-frustum based on the determined limit boundaries of the ROI.

In some aspects, the techniques described herein relate to a method, where the set of limit boundaries includes: a topmost limit boundary of the ROI; a bottommost limit boundary of the ROI; a leftmost limit boundary of the ROI; and a rightmost limit boundary of the ROI.

In some aspects, the techniques described herein relate to a method, where the FoV includes at least one of: a left boundary indicator that is at least as far left as the leftmost limit boundary of the ROI; a right boundary indicator that is at least as far right as the rightmost limit boundary of the ROI; a top boundary indicator that at least as high as the topmost limit boundary of the ROI; or a bottom boundary indicator that is at least as low as the bottommost limit boundary of the ROI.

In some aspects, the techniques described herein relate to a method, where a first size of the configured FOV is smaller than a second size of a second FOV of the composition frame.

In some aspects, the techniques described herein relate to a method, where a first scale and a first orientation of the rendered layer is equal to a second scale and a second orientation of the composition frame.

In some aspects, the techniques described herein relate to a method, further including: configuring a second render-frustum of a second layer of the composition frame based on the head pose of the user and a second ROI corresponding with the second layer; rendering the second layer based on the configured second render-frustum; and outputting a third indication of the rendered second layer.

In some aspects, the techniques described herein relate to a method, where outputting the third indication of the rendered second layer includes: composing the composition frame based on the rendered first layer and the rendered second layer.

In some aspects, the techniques described herein relate to a method, where a first size of the ROI is not equal to a second size of the second ROI.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3 illustrates an example image or surface in accordance with one or more techniques of this disclosure.

FIG. 4 illustrates an example of a set of rendered layers that may be used for composition and/or reprojection of a frame, in accordance with one or more techniques of this disclosure.

FIG. 5 illustrates another example of a set of rendered layers that may be used for composition and/or reprojection of a frame, in accordance with one or more techniques of this disclosure.

FIG. 6 illustrates another example of a set of rendered layers that may be used for composition and/or reprojection of a frame, in accordance with one or more techniques of this disclosure.

FIG. 7 illustrates an example of an asymmetric frustum for a rendering camera, in accordance with one or more techniques of this disclosure.

FIG. 8A illustrates an example of a left angle and a right angle defining a horizontal field of view (FoVₓ), in accordance with one or more techniques of this disclosure.

FIG. 8B illustrates another example of a left angle and a right angle defining a FoVₓ, in accordance with one or more techniques of this disclosure.

FIG. 8C illustrates another example of a left angle and a right angle defining a FoVₓ, in accordance with one or more techniques of this disclosure.

FIG. 9 is a call flow diagram illustrating example communications between a CPU and a GPU in accordance with one or more techniques of this disclosure.

FIG. 10 is a flowchart of an example method of graphics processing, in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

The following description is directed to examples for the purposes of describing innovative aspects of this disclosure. However, a person having ordinary skill in the art may recognize that the teachings herein may be applied in a multitude of ways. Some or all of the described examples may be implemented in any device or system that is capable of processing graphics commands. Various aspects relate generally to reprojecting and/or composing frames for a graphics processing unit (GPU). Some aspects more specifically relate to applying reprojection fallback strategies during an excess system load (e.g., when a reprojection process for a frame will not complete in time to display the frame). For example, a graphics system may have limited dynamic random access memory (DRAM) bandwidth due to concurrent work (e.g., rendering, GPU workload, high-intensity periods of camera data acquisition), software control latencies (e.g., poorly optimized code, latencies when communicating with third-party applications), bottlenecking hardware execution, and/or power/thermal throttling. Such loads may affect the calculated projected time for a reprojection process to complete within a threshold period of time. Use of remotely-rendered framebuffers (e.g., frames processed by a reprojection topology on a separate system, or a third-party system), may also affect the time to render a frame. For example, use of a second reprojection process may conserve resources if a first reprojection process uses remote-rendered framebuffers having a high calculated latency value, or if a first reprojection process uses a large amount of bandwidth (e.g., WiFi, 5G bandwidth) and a system is configured to conserve use of that bandwidth with respect to transmission/reception of remote-rendered frames.

In some examples, a graphics processor (or graphics processor system) may obtain a first indication of a composition frame. The composition frame may include a set of layers, where each rendered layer may be combined to generate a frame that includes a composition of the set of layers. The graphics processor may configure a render-frustum of a layer of the composition frame based on a head pose of a user and a region of interest (ROI) corresponding with the layer in response to the obtainment of the first indication. A render-frustum may be a frustum bounded by, a near plane, a far plane, and a field of view (FoV) of a rendering camera. A rendering engine may be configured to render objects located between the near plane and far plane within the FoV to render a frame. The graphics processor may render the layer based on the configured render-frustum. The graphics processor may output a second indication of the rendered layer.

A graphics processor configured to generate a reprojection for a composition frame based on a head movement of a wearer of an artificial reality (AR) device may generate edge artifacts due to missing data at the edges of an object in a frame. In some aspects, the graphics processor may be configured to over-render by increasing the render layer's FoV relative to the display FoV. However, over-rendering may degrade the overall visual quality of the frame as over-rendering decreases pixel density (e.g., reduced pixels per degree (PPD)). In other aspects, the graphics processor may, for sparse content, avoid edge artifacts by dynamically adjusting the render-frustum of each layer to shift the sparse content toward the “center” of a layer. The graphics processor may dynamically adjust the left, right, up, and down angles of the render layer's FoV to place the object of interest in the center of the frustum, or within the boundaries of the render layer's FoV. Such a graphics processor may ensure that there exists sufficient edge-content to avoid artifacts.

Particular aspects of the subject matter described in this disclosure can be implemented to realize one or more of the following potential advantages. In some examples by dynamically adjusting the render-frustum of a layer around a ROI of the layer, the described techniques can be used to reduce edge artifacts when a user adjusts a head pose while avoiding sacrificing visual quality.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

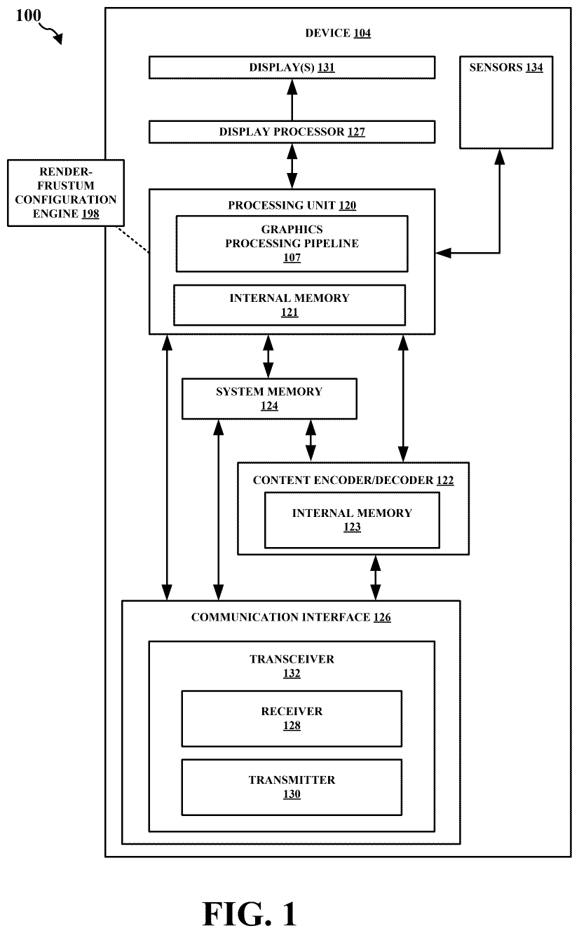

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory”may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

The device 104 may include an AR, virtual reality (VR), or an extended reality (XR) device having a plurality of displays, one for each eye of a user wearing the device 104, to show a three-dimensional (3D) view of a scene to the user. The device 104 may include a set of sensors 134, which may track movements of the user. The set of sensors 134 may include, for example, a head pose sensor that tracks the head pose of the user, an eye focus sensor that tracks the gaze direction of an eye of the user, an accelerometer that tracks a movement of the device 104, or a user interface (UI) that accepts inputs from the user, such as a button or a speaker. The set of sensors 134 may include a camera, an accelerometer, a barometric pressure sensor, an altimeter, a motion sensor such as inertial measurement unit (IMU), a gyroscope, a microphone, and/or a magnetometer. In some aspects, the device 104 may receive an indicator of sensor data from a set of sensors. For example, the receiver 128 may receive a wireless signal that indicates sensor data from a remote AR or XR device worn by a user, allowing the processing unit 120 to render frames based on the sensor data (e.g., a head pose and/or an eye focus of the user).

Referring again to FIG. 1, in certain aspects, the processing unit 120 may include a render-frustum configuration engine 198 configured to obtain a first indication of a composition frame. The render-frustum configuration engine 198 may be configured to configure a render-frustum of a layer of the composition frame based on a head pose of a user and a region of interest (ROI) corresponding with the layer in response to the obtainment of the first indication. The render-frustum configuration engine 198 may be configured to render the layer based on the configured render-frustum. The render-frustum configuration engine 198 may be configured to output a second indication of the rendered layer. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

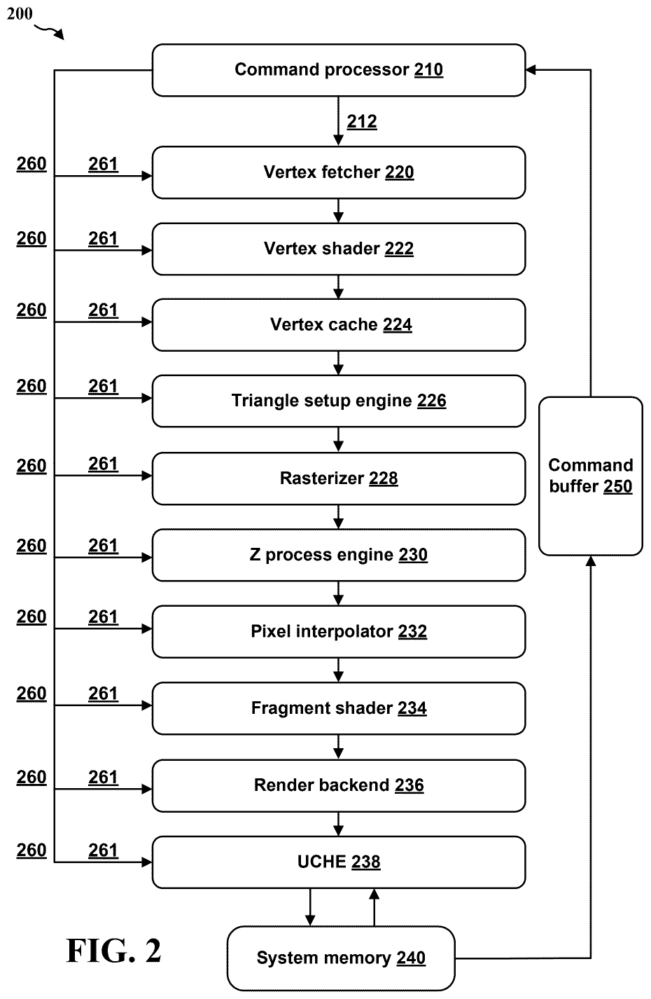

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

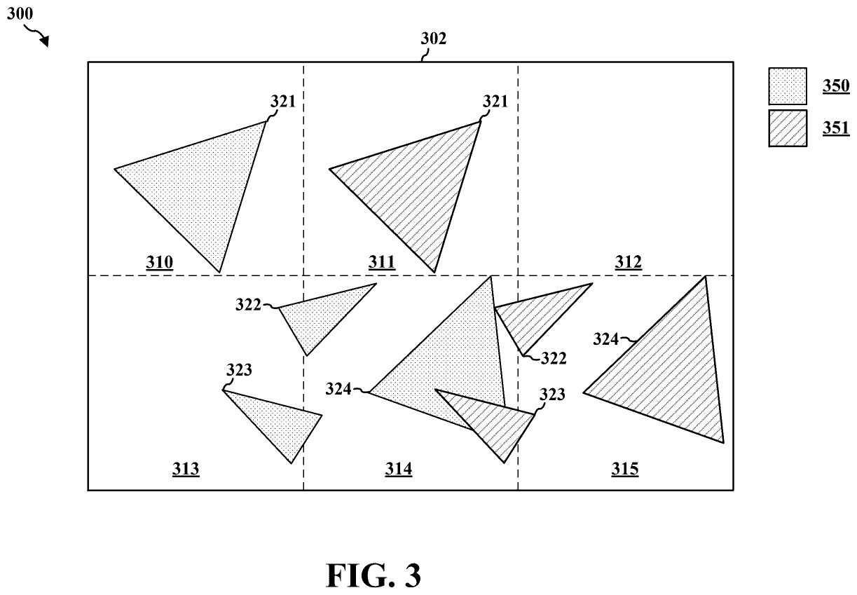

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

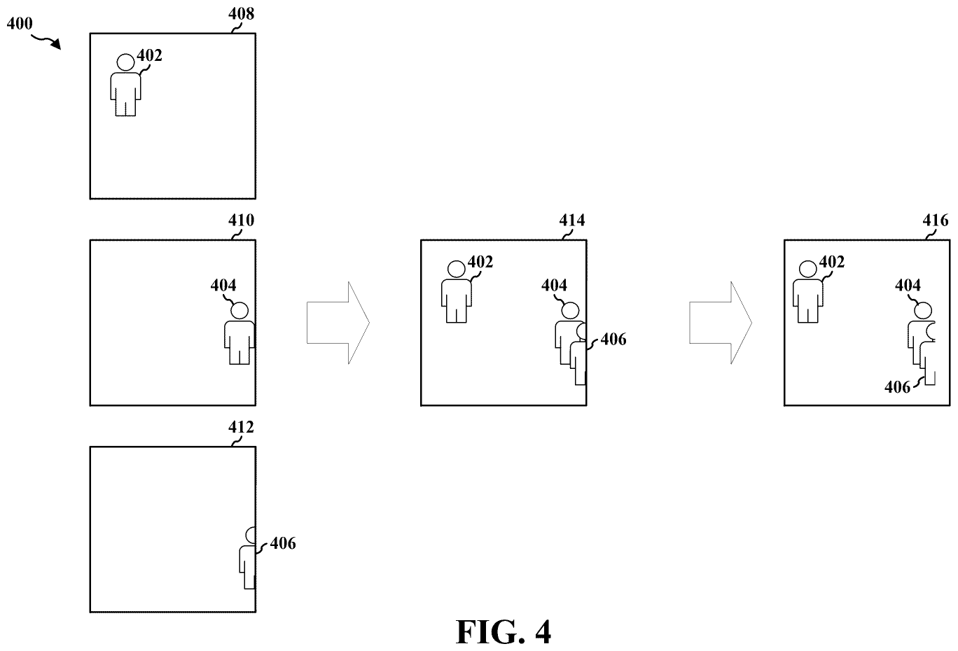

FIG. 4 is a diagram 400 that illustrates an example of a set of rendered layers, such as the rendered layer 408, the rendered layer 410, and the rendered layer 412, where the set of layers may be used a composition, as shown by the composition frame 414, and/or a reprojection, as shown by the reprojection frame 416. The set of rendered layers may be content location aligned. The composition frame 414 or the reprojection frame 416 may display content in a display space based on set of rendered layers.

A graphics processing system, such as an AR/VR topology, may generate independent sparse content layers for a frame, which may be reprojected or head-pose changes and then composed together to generate a final display image. For example, the graphics processing system may generate layers with location aligned content. The graphics processing system may render layers having the same, or similar (e.g., ±5% tolerance) scale and/or orientation as the display frame. The graphics processing system may render layers having the same, or similar (e.g., ±5% tolerance) pixel alignment as the display frame. The graphics processing system may re-render a layer in response to the difference between a render-pose and current head-pose to be greater than or equal to a threshold in translation and/or rotation. The graphics processing system may re-render a layer in response to obtaining an indication that a layer content has been updated, for example if a character object animates.

A graphics processing system may render the rendered layer 408 having an object 402, the rendered layer 410 having an object 404, and the rendered layer 412 having the object 406. The graphics processing system may render the rendered layers and objects based on a last known head pose of a user via a FoV defined by the display frame. The graphics processing system may render a portion of the object 406 based on the FoV of the display frame, and a portion of the object 406 may not be visible within the FoV of the display frame (i.e., a portion of the object 406 may have invisible primitives). The graphics processing system may generate a composition based on the set of rendered layers as the composition frame 414. The composition of the composition frame 414 may be a view of the object 402, the object 404, and the object 406 based on the FoV of the display frame. The graphics processing system may calculate the FoV based on at least one of a head pose of a user or a set of eye gazes of the user.

In some aspects, the graphics processing system may re-render the composition frame 414. For example, the graphics processing system may obtain an indication that a head pose of a user has changed from the last known head pose by more than a threshold amount. In response, the graphics processing system may reproject the composition frame 414 based on the change in the head pose as the reprojection frame 416. However, the reprojection frame 416 may display a portion of the object 406, as the original FoV of the display frame did not have a view of portion of the object 406 which now should be visible. This may result in edge artifacts, such as missing edge data, blurred data, or otherwise incomplete data for displaying a portion of the object 406. In other words, reprojecting for head movement may cause the graphics processing system to introduce edge artifacts due to missing data at the edges. In devices, such as AR/VR/XR devices, such edge artifacts may be distracting to a user.

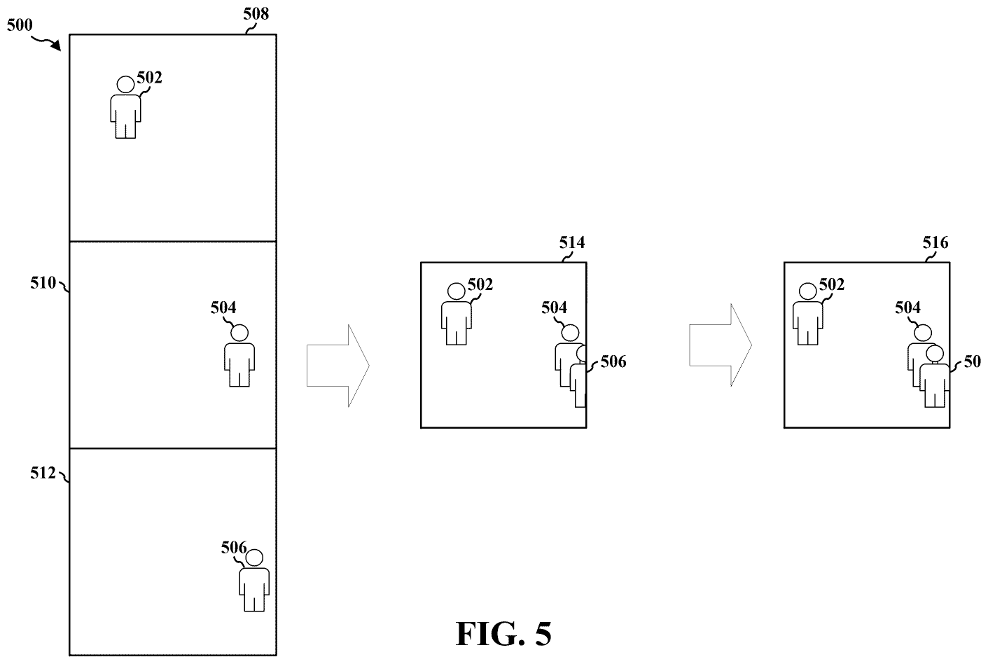

FIG. 5 is a diagram 500 that illustrates another example of a set of rendered layers, such as the rendered layer 508, the rendered layer 510, and the rendered layer 512, where the set of layers may be used a composition, as shown by the composition frame 514, and/or a reprojection, as shown by the reprojection frame 516. The set of rendered layers may be content location aligned. The composition frame 514 or the reprojection frame 516 may display content in a display space based on set of rendered layers.

The set of rendered layers may be over-rendered. In other words, the graphics processing system may increase the FoV of the render layer relative to the display FoV. For example, if a head pose and/or eye gaze of a user indicates that a user is looking in a direction with a given near plane, far plane, left angle, right angle, up angle, and down angle that defines a FoV for the user, the graphics processing system may set the FoV of the render layer to have a greater left angle and right angle (greater horizontal FoV (FoVₓ)), a greater up angle and down angle (greater vertical FoV (FoV_{y})), or both a greater FoVₓ and a greater FoV_{y}. The graphics processing system, such as an AR/VR topology, may render the rendered layer 508 having an object 502, the rendered layer 510 having an object 504, and the rendered layer 512 having the object 506. Each of the rendered layer 508, the rendered layer 510, and the rendered layer 512 may have a FoV that is greater than the FoV of the composition frame 514. The FoV of the composition frame 514 may be determined based on a last known head pose of a user. In other words, the last known head pose of the user may define via a FoV of the display frame. The graphics processing system may render an entirety of the object 506 based on the increased FoV of the rendered layer 512. The graphics processing system may generate a composition based on the set of rendered layers as the composition frame 514. The composition of the composition frame 514 may be a view of the object 502, the object 504, and the object 506 based on the FoV of the display frame. The graphics processing system may calculate the FoV based on at least one of a head pose of a user or a set of eye gazes of the user.

In some aspects, the graphics processing system may re-render the composition frame 514. For example, the graphics processing system may obtain an indication that a head pose of a user has changed from the last known head pose by more than a threshold amount. In response, the graphics processing system may reproject the composition frame 514 based on the change in the head pose as the reprojection frame 516. The reprojection frame 516 may display the entirety of the object 506, as the increased FoV of the rendered layer 512 is greater than the FoV of the display frame, allowing the graphics processing system to capture the entirety of the object 506 for rendering. However, this may degrade the visual quality of both the composition frame 514 and the reprojection frame 516, as over-rendering directly decreases pixel density. In other words, the PPD of the composition frame 514 may have a lower PPD than the composition frame 414 in FIG. 4. The effect may be worse at the edges, as the angle per pixel may be larger due to over-rendering. The amount of visual quality loss may be proportional to the increase in the FoV. A larger FoV over-render may yield significant quality loss. While the loss of detail may be minimized by improving the resolution of the rendered layer, increasing the resolution may be inefficient as pixel-count may increase with the square of the resolution (i.e., doubling a resolution may mean increasing the pixel-count by a factor equal to the pixel-count). A graphics processing system on a mobile device may have constrained power/memory resources, and increasing a buffer size may not be a viable option for such devices.

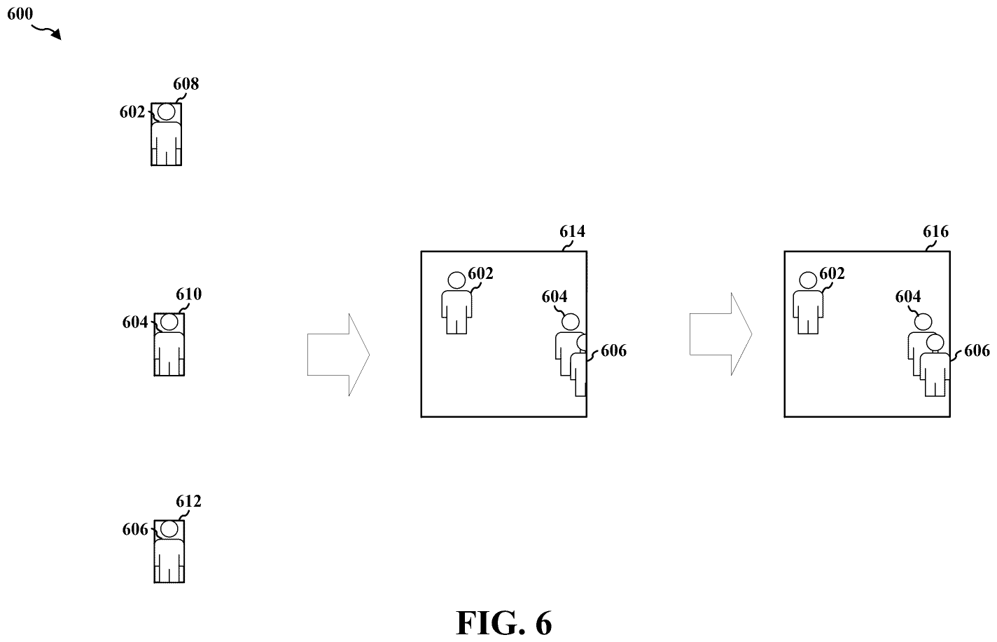

FIG. 6 is a diagram 600 that illustrates another example of a set of rendered layers, such as the rendered layer 608, the rendered layer 610, and the rendered layer 612, where the set of layers may be used a composition, as shown by the composition frame 614, and/or a translation, as shown by translation frame 616. The set of rendered layers may be content location aligned. The composition frame 614 or the translation frame 616 may display content in a display space based on set of rendered layers.

A graphics processing system may render the set of rendered layers based on a dynamically adjusted render-frustum to shift sparse content toward the center of the rendered layer to avoid running out of data at the edges during reprojection. The graphics processing system may render the set of rendered layers having the same, or similar (e.g., ±5% tolerance) scale and/or orientation as the display frame. The graphics processing system may render the set of rendered layers having the same, or similar (e.g., ±5% tolerance) pixel alignment as the display frame. The graphics processing system may render the set of rendered layers having a fixed, or variable, content size. For example, the content size may be smaller than the display frame, fixed at a size of the object based on the head pose assuming a FoV defined by the boundaries of the object. In some aspects, for example if the object of a frame has a 3D structure and the head pose of the user changes to expose a larger dimension of the object that does not fit within the original tight bounding box size of the rendered layer, the graphics processing system may vary the content size. Similarly, if the object of the rendered layer moves towards or away from the viewer, the apparent size may change and, in response to an indication that the apparent size changes by at least a threshold value, the graphics processing system may adjust the bounding box of the object accordingly. In other words, the graphics processing system may adjust the content size to ensure that no portion of the object is cut off as the scene evolves. A content size may be the dimensions of a bounding box, as defined by a rendering camera and a last known head pose and/or set of eye gazes of a user.

The graphics processing system, such as an AR/VR topology, may render the rendered layer 608 having an object 602, the rendered layer 610 having an object 604, and the rendered layer 612 having the object 606. Each of the rendered layer 608, the rendered layer 610, and the rendered layer 612 may have a FoV that is defined by a bounding box of an identified object associated with the layer. The FoV of the composition frame 614 may be determined based on a last known head pose of a user and determined boundaries of an identified object, or set of identified objects, associated with the layer. In other words, the last known head pose of the user and all objects that may be seen from that last known head pose assuming an infinite FoV may define via a FoV of each corresponding rendered layer. The graphics processing system may render an entirety of the object 602 in the rendered layer 608, the entirety of the object 604 in the rendered layer 610, and the entirety of the object 606 in the rendered layer 612 based on the corresponding FOV of the rendered frame. The graphics processing system may generate a composition based on the set of rendered layers as the composition frame 614. The composition of the composition frame 614 may be a view of the object 602, the object 604, and the object 606 based on the FoV of the display frame. The graphics processing system may calculate the FoV based on at least one of a head pose of a user or a set of eye gazes of the user. The composition frame 614 may not display all of the object 606 that was rendered in the rendered layer 612, as the FoV of the display frame may not display the primitives of portions of the object 606.

In some aspects, the graphics processing system may re-render the composition frame 614. For example, the graphics processing system may obtain an indication that a head pose of a user has changed from the last known head pose by more than a threshold amount. In response, the graphics processing system may translate the composition frame 614 based on the change in the head pose as the translation frame 616. The translation frame 616 may display the entirety of the object 606, as the rendered layer 612 may include the entirety of the object 606, allowing the graphics processing system to capture the entirety of the object 606 for translation. Such a graphics processing system may avoid edge effects without a loss in visual quality and/or an increase in render size/resources used. The graphics processing system may not re-render any of the frames in response to a horizontal or vertical translation (x/y-translation) as each of the object 602, the object 604, and the object 606 have been completely rendered based on the dynamically adjusted render-frustum. The graphics processing system may instead re-render the composition frame 614 based on a difference between a current head-pose and a render pose being greater or equal to a threshold in rotation or z-translation (e.g., zooming in or out). By rendering layers based on a dynamic render-frustum the graphics processing system may avoid edge artifacts and ensure that there is sufficient edge content to avoid such edge artifacts. Such graphics processing systems may avoid visual quality reduction as the content may be rendered at a similar, or greater, scale, orientation, and/or resolution as the display frame. Such graphics processing systems may avoid using oversized render buffers or higher resolution rendering, while also avoiding edge artifacts.

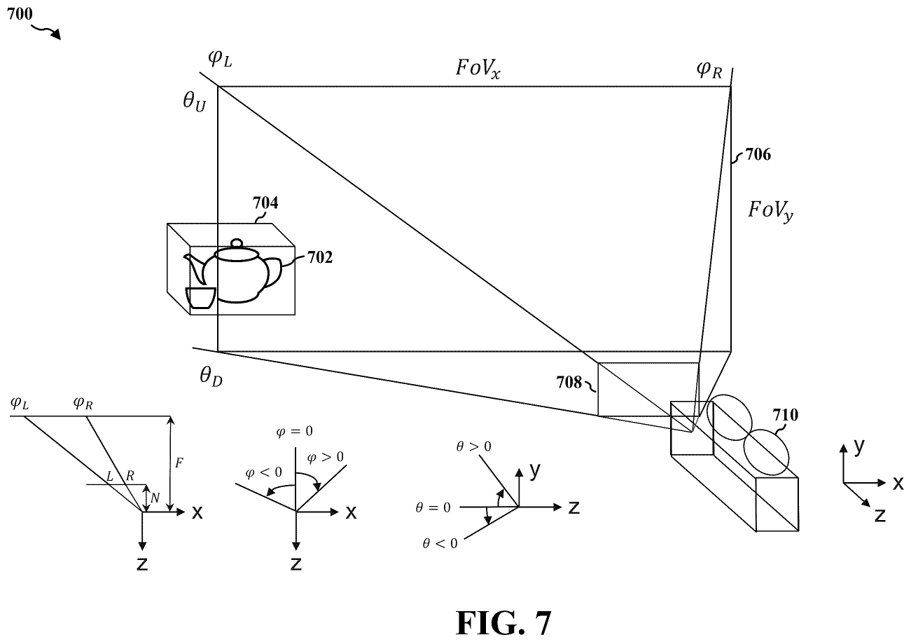

FIG. 7 is a diagram 700 illustrating an example of an asymmetric frustum for a rendering camera 710, in accordance with one or more techniques of this disclosure. The location and orientation of the rendering camera 710 may be based on at least one of a head pose or a set of eye gazes of a user. A graphics processing system may be configured to render objects captured by the rendering camera 710 having a viewing angle defined by a viewing area of an application. The application may define the far plane distance F and the near plane distance N, as well as the up angle θ_{U}, the down angle θ_{D}, the left angle φ_{L}, and the right angle φ_{R} of the viewing area. The left angle φ_{L}, and the right angle φ_{R} may define an FoVₓ of the FoV of the display frame, and the up angle θ_{U}, the down angle θ_{D} may define an FoV_{y} of the FoV of the display frame. The far plane distance F may define the distance of the far plane 706 from the apex of the rendering camera 710. The near plane distance N may define the distance of the near plane 708 from the apex of the rendering camera 710. In some aspects, an application can indicate where the ROI is for a certain render layer, which will influence the asymmetric frustum configuration.

A graphics processing system may calculate a projection matrix P based on the following formula:

$$P = [ \begin{matrix}\frac{2 N}{R - L} & 0 & \frac{R + L}{R - L} & 0 \\ 0 & \frac{2 N}{T - B} & \frac{T + B}{T - B} & 0 \\ 0 & 0 & \frac{N + F}{N - F} & \frac{2 NF}{N - F} \\ 0 & 0 & - 1 & 0\end{matrix} ]$$

Where L=N*tan(φ_{L}), R=N*tan(φ_{R}), T=N*tan (θ_{U}), and B=N*tan (θ_{D}).

As is shown in diagram 700, a default display frame may render portions of a view that do not include the object 702. The boundaries of the object 702 may be defined by a bounding box 704. The boundaries of the bounding box 704 may be calculated based on a topmost point, bottommost point, leftmost point, and rightmost point of the object 702 as seen from the apex of the rendering camera 710 assuming an infinite FoV. For example, the bounding box 704 may be set to have dimensions that perfectly bound the topmost point, bottommost point, leftmost point, and rightmost point of the object 702 as seen from the apex of the rendering camera 710 assuming an infinite FoV. In another aspect, the bounding box 704 may be set to have dimensions 5 pixels or 10 pixels greater in every direction from the topmost point, bottommost point, leftmost point, and rightmost point of the object 702 as seen from the apex of the rendering camera 710 assuming an infinite FoV-providing a visual buffer in case of inaccuracies in estimating at least one of the aforementioned points.

The bounding box 704 may define a region of interest (ROI) associated with the layer corresponding with the object 702. The graphics processing system may adjust the render-frustum to be bounded by the bounding box 704. In other words, the graphics processing system may configure the render-frustum of the layer to have a FoV defined by the bounding box 704, and not by the FoV of the display frame.

In some aspects, the far plane distance F and the near plane distance N may be flexibly configurable alongside T, B, L, and/or R. In other aspects, the far plane distance F and the near plane distance N may be obtained by an application. In some aspects, a frustum configuration engine may optimize the configurability of N and F to avoid similar edge artifacts in the Z direction (i.e., optimize visual quality). Similarly, the values of T, B, L, and R may impact edge artifacts in the X and Y directions. The T, B, L, and R angles may cover at least the limits of the bounding box around the COI

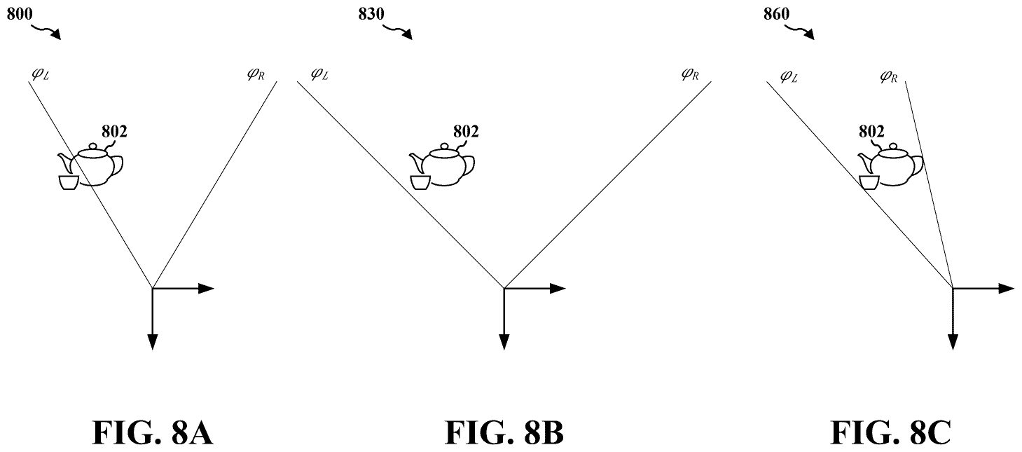

FIG. 8A is a diagram 800 that illustrates an example of a left angle φ_{L} and a right angle φ_{R} defining a FoVₓ of a frame that includes an object 802, in accordance with one or more techniques of this disclosure. The FoVₓ shown in diagram 800 may be defined by a FoV of a display frame. As shown, the FoVₓ may not show all of the object 802 from the apex of a rendering camera, as not all of the object 802 is visible via the FoVₓ. In other words, some of the primitives of the object 802 may not be visible via the FoVₓ. A translation in the head pose of a user in the horizontal or vertical direction may result in a view of the object 802 with an edge artifact.

FIG. 8B is a diagram 830 that illustrates another example of a left angle φ_{L} and a right angle φ_{R} defining a FoVₓ of a frame that includes the object 802, in accordance with one or more techniques of this disclosure. The FoVₓ shown in diagram 830 may be an over-render of the FoV of a display frame. As shown, the FoVₓ may show all of the object 802 from the apex of a rendering camera, allowing a translation in the head pose of a user in the horizontal or vertical direction to easily result in a view of the object 802 without an edge artifact. However, over-rendering using the FoVₓ in FIG. 8B may result in a decrease in visual quality or an increase in resources, as explained above.

FIG. 8C is a diagram 860 that illustrates another example of a left angle φ_{L} and a right angle φ_{R} defining a FoVₓ of a frame that includes the object 802, in accordance with one or more techniques of this disclosure. The FoVₓ shown in diagram 860 may be a dynamically adjusted render-frustum based on the limits of the object 802 as viewed from the apex of a rendering camera. As shown, the FoVₓ may show all of the object 802 from the apex of a rendering camera, allowing a translation in the head pose of a user in the horizontal or vertical direction to easily result in a view of the object 802 without an edge artifact. Since the FoVₓ in FIG. 8C is less than the FoVₓ in FIG. 8A that represents the FoV of the display frame, rendering the object 802 using the FoVₓ in FIG. 8C may result in less resources being used to render the object 802, while still preserving the visual quality of the rendering. Moreover, a graphics processor system may even increase the resolution of the rendering of the object 802 while still preserving quality, allowing for an increase in visual quality in some aspects.

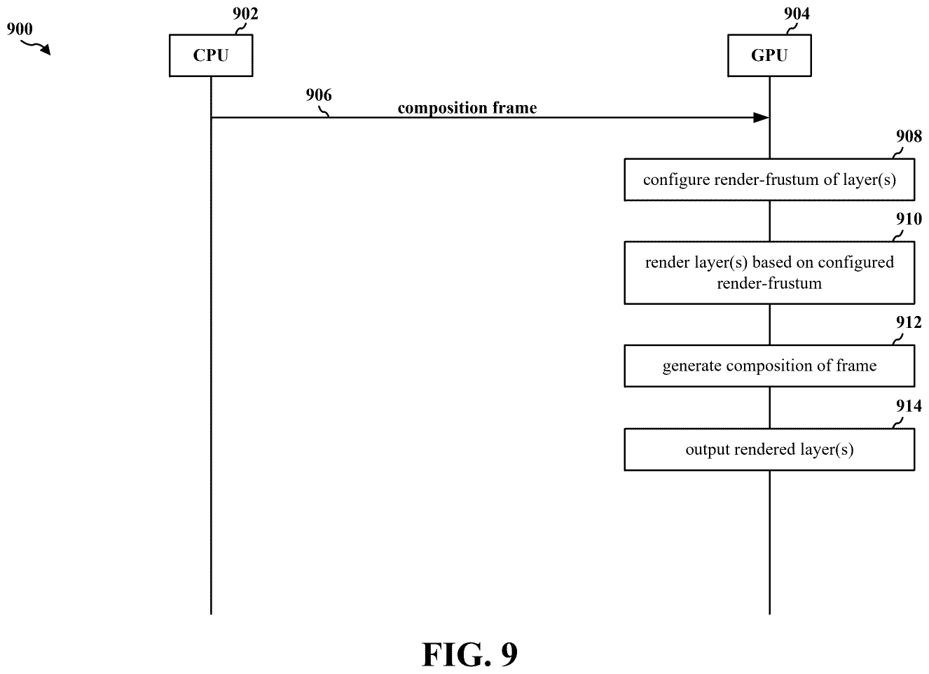

FIG. 9 is a call flow diagram 900 illustrating example communications between a CPU 902 and a GPU 904 in accordance with one or more techniques of this disclosure.

The CPU 902 may transmit an indication of a composition frame 906 to the GPU 904. The GPU 904 may receive the indication of the composition frame 906 from the CPU 902. The composition frame 906 may include a composition of a set of frames, where each frame is associated with a set of objects rendered in the frame. In some aspects, each of the set of frames is associated with exactly one object rendered in the frame.

At 908, the GPU 904 may dynamically configure a render-frustum for each of the set of layers associated with the composition frame 906. The dynamic configuration of the render-frustum may be based on a ROI that bounds the set of objects corresponding with the frame.

At 910, the GPU 904 may render each of the layers based on the set of render-frustum configured at 908. Each of the rendered layers may display an entirety of the set of objects as seen based on a head pose of a user. At 912, the GPU 904 may generate a composition of a frame based on the set of rendered layers. For example, the GPU 904 may compose a composition frame based on the plurality of layers after the render of the layer based on the configured render-frustum. At 914, the GPU 904 may output the rendered layers, for example to a display for displaying or to a rendering/translating engine that may re-render a frame based on an updated head pose of a user.

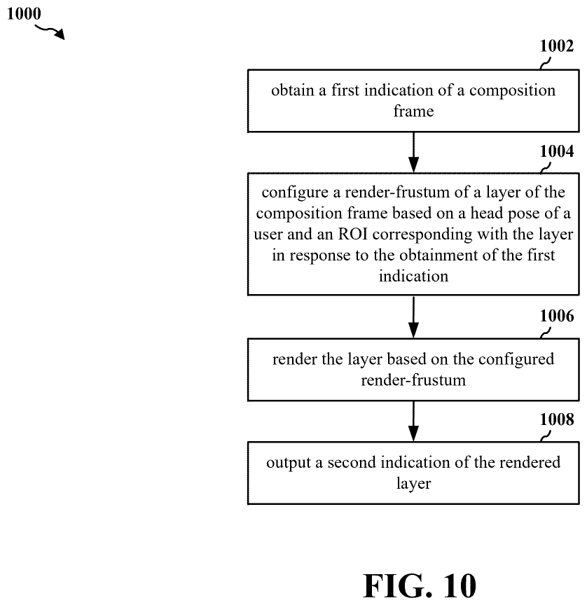

FIG. 10 is a flowchart 1000 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-7, 8A, 8B, 8C, and 9.

At 1002, the apparatus may obtain a first indication of a composition frame. For example, 1002 may be performed by the GPU 904 in FIG. 9, which may obtain a first indication of a composition frame. Moreover, 1002 may be performed by the render-frustum configuration engine 198 in FIG. 1.

At 1004, the apparatus may configure a render-frustum of a layer of the composition frame based on a head pose of a user and an ROI corresponding with the layer in response to the obtainment of the first indication. For example, 1004 may be performed by the GPU 904 in FIG. 9, which may configure a render-frustum of a layer of the composition frame based on a head pose of a user and an ROI corresponding with the layer in response to the obtainment of the first indication. Moreover, 1004 may be performed by the render-frustum configuration engine 198 in FIG. 1.

At 1006, the apparatus may render the layer based on the configured render-frustum. For example, 1006 may be performed by the GPU 904 in FIG. 9, which may render the layer based on the configured render-frustum. Moreover, 1006 may be performed by the render-frustum configuration engine 198 in FIG. 1. Additionally, the apparatus may compose a composition frame based on the plurality of layers after the render of the layer based on the configured render-frustum.

At 1008, the apparatus may output a second indication of the rendered layer. For example, 1008 may be performed by the GPU 904 in FIG. 9, which may output a second indication of the rendered layer. Moreover, 1008 may be performed by the render-frustum configuration engine 198 in FIG. 1.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for obtaining a first indication of a composition frame. The apparatus may further include means for configuring a render-frustum of a layer of the composition frame based on a head pose of a user and an ROI corresponding with the layer in response to the obtainment of the first indication. The apparatus may further include means for rendering the layer based on the configured render-frustum. The apparatus may further include means for outputting a second indication of the rendered layer.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing, comprising: obtaining a first indication of a composition frame; configuring a render-frustum of a layer of the composition frame based on a head pose of a user and a region of interest (ROI) corresponding with the layer in response to the obtainment of the first indication; rendering the layer based on the configured render-frustum; and outputting a second indication of the rendered layer.

Aspect 2 is the method of aspect 1, wherein the first indication indicates a plurality of layers, wherein the composition frame comprises the plurality of layers, wherein the plurality of layers comprises the layer.

Aspect 3 is the method of aspect 2, further comprising: composing the composition frame based on the plurality of layers after the render of the layer based on the configured render-frustum.

Aspect 4 is the method of any of aspects 1 to 3, wherein configuring the render-frustum of the layer of the composition frame comprises: identifying a content of interest (COI) of the layer; determining a set of limit boundaries for the ROI based on the identification of the COI; and configuring a field of view (FoV) of the render-frustum based on the determined limit boundaries of the ROI.

Aspect 5 is the method of aspect 4, wherein the set of limit boundaries comprises: a topmost limit boundary of the ROI (T); a bottommost limit boundary of the ROI (B); a leftmost limit boundary of the ROI (L); and a rightmost limit boundary of the ROI (R). In other aspects, the set of limit boundaries may also comprise a near-most limit boundary of the ROI (N) and a far-most limit boundary of the ROI (F). In other words, the method may include configuring the set of limit boundaries of T, B, L, and R, and in some aspects also N and F of the asymmetric frustum. The configuration of the T, B, L, and R limit boundaries may impact edge-artifacts in the X and Y direction, while the configuration of the N and F limit boundaries may impact edge-artifacts in the Z direction.

Aspect 6 is the method of aspect 5, wherein the FoV comprises at least one of: a left boundary indicator that is at least as far left as the leftmost limit boundary of the ROI; a right boundary indicator that is at least as far right as the rightmost limit boundary of the ROI; a top boundary indicator that at least as high as the topmost limit boundary of the ROI; or a bottom boundary indicator that is at least as low as the bottommost limit boundary of the ROI.

Aspect 7 is the method of any of aspects 4 to 6, wherein a first size of the configured FoV is smaller than a second size of a second FoV of the composition frame.

Aspect 8 is the method of any of aspects 4 to 7, wherein a first scale and a first orientation of the rendered layer is equal to a second scale and a second orientation of the composition frame.

Aspect 9 is the method of any of aspects 1 to 8, further comprising: configuring a second render-frustum of a second layer of the composition frame based on the head pose of the user and a second ROI corresponding with the second layer; rendering the second layer based on the configured second render-frustum; and outputting a third indication of the rendered second layer.

Aspect 10 is the method of aspect 9, wherein outputting the third indication of the rendered second layer comprises: composing the composition frame based on the rendered first layer and the rendered second layer.

Aspect 11 is the method of either of aspects 9 or 10, wherein a first size of the ROI is not equal to a second size of the second ROI.

Aspect 12 is an apparatus for graphics processing including at least one processor coupled to a memory and configured to implement a method as in any of aspects 1-11.

Aspect 13 may be combined with aspect 12 and includes that the apparatus is a wireless communication device.

Aspect 14 is an apparatus for graphics processing including means for implementing a method as in any of aspects 1-11.

Aspect 15 is a computer-readable medium (e.g. a non-transitory computer-readable medium) storing computer executable code, the code when executed by at least one processor causes the at least one processor to implement a method as in any of aspects 1-11.

Various aspects have been described herein. These and other aspects are within the scope of the following claims.

What is claimed is:

1. An apparatus for graphics processing, comprising:
a memory; and
a processor coupled to the memory and, based at least in part on information stored in the memory, the processor is configured to:
obtain a first indication of a composition frame;
configure a render-frustum of a layer of the composition frame based on a head pose of a user and a region of interest (ROI) corresponding with the layer in response to the obtainment of the first indication;
render the layer based on the configured render-frustum; and
output a second indication of the rendered layer.

2. The apparatus of claim 1, wherein the first indication indicates a plurality of layers, wherein the composition frame comprises the plurality of layers, wherein the plurality of layers comprises the layer.

3. The apparatus of claim 2, wherein the processor is further configured to:
compose the composition frame based on the plurality of layers after the render of the layer based on the configured render-frustum.

4. The apparatus of claim 1, wherein, to configure the render-frustum of the layer of the composition frame, the processor is configured to:
identify a content of interest (COI) of the layer;
determine a set of limit boundaries for the ROI based on an identification of the COI; and
configure a field of view (FoV) of the render-frustum based on the determined limit boundaries of the ROI.

5. The apparatus of claim 4, wherein the set of limit boundaries comprises:
a topmost limit boundary of the ROI;
a bottommost limit boundary of the ROI;
a leftmost limit boundary of the ROI; and
a rightmost limit boundary of the ROI.

6. The apparatus of claim 5, wherein the FoV comprises at least one of:
a left boundary indicator that is at least as far left as the leftmost limit boundary of the ROI;
a right boundary indicator that is at least as far right as the rightmost limit boundary of the ROI;
a top boundary indicator that at least as high as the topmost limit boundary of the ROI; or
a bottom boundary indicator that is at least as low as the bottommost limit boundary of the ROI.

7. The apparatus of claim 4, wherein a first size of the configured FoV is smaller than a second size of a second FoV of the composition frame.

8. The apparatus of claim 4, wherein a first scale and a first orientation of the rendered layer is equal to a second scale and a second orientation of the composition frame.

9. The apparatus of claim 1, wherein the processor is further configured to:
configure a second render-frustum of a second layer of the composition frame based on the head pose of the user and a second ROI corresponding with the second layer;
render the second layer based on the configured second render-frustum; and
output a third indication of the rendered second layer.

10. The apparatus of claim 9, wherein, to output the third indication of the rendered second layer, the processor is configured to:
compose the composition frame based on the rendered first layer and the rendered second layer.

11. The apparatus of claim 9, wherein a first size of the ROI is not equal to a second size of the second ROI.

12. A method of graphics processing, comprising:
obtaining a first indication of a composition frame;
configuring a render-frustum of a layer of the composition frame based on a head pose of a user and a region of interest (ROI) corresponding with the layer in response to the obtainment of the first indication;
rendering the layer based on the configured render-frustum; and
outputting a second indication of the rendered layer.

13. The method of claim 12, wherein the first indication indicates a plurality of layers, wherein the composition frame comprises the plurality of layers, wherein the plurality of layers comprises the layer.

14. The method of claim 13, further comprising:
composing the composition frame based on the plurality of layers after the render of the layer based on the configured render-frustum.

15. The method of claim 12, wherein configuring the render-frustum of the layer of the composition frame comprises:
identifying a content of interest (COI) of the layer;
determining a set of limit boundaries for the ROI based on an identification of the COI; and
configuring a field of view (FoV) of the render-frustum based on the determined limit boundaries of the ROI.

16. The method of claim 15, wherein the set of limit boundaries comprises:
a topmost limit boundary of the ROI;
a bottommost limit boundary of the ROI;
a leftmost limit boundary of the ROI; and
a rightmost limit boundary of the ROI.

17. The method of claim 16, wherein the FoV comprises at least one of:
a left boundary indicator that is at least as far left as the leftmost limit boundary of the ROI;
a right boundary indicator that is at least as far right as the rightmost limit boundary of the ROI;
a top boundary indicator that at least as high as the topmost limit boundary of the ROI; or
a bottom boundary indicator that is at least as low as the bottommost limit boundary of the ROI.

18. The method of claim 12, further comprising:
configuring a second render-frustum of a second layer of the composition frame based on the head pose of the user and a second ROI corresponding with the second layer;
rendering the second layer based on the configured second render-frustum; and
outputting a third indication of the rendered second layer.

19. The method of claim 18, wherein outputting the third indication of the rendered second layer comprises:
composing the composition frame based on the rendered first layer and the rendered second layer.

20. A computer-readable medium storing computer executable code, the code when executed by a processor, causes the processor to:
obtain a first indication of a composition frame;
configure a render-frustum of a layer of the composition frame based on a head pose of a user and a region of interest (ROI) corresponding with the layer in response to the obtainment of the first indication;
render the layer based on the configured render-frustum; and
output a second indication of the rendered layer.
